(19) United States
(12) Patent Application Publication
(10) Pub. No.: US 2003/0118030 A1
(43) Pub. Date: Jun. 26, 2003

(54) Optical communication system and optical communication method

(75) Inventor: Toshiya Fukuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/173,646

(22) Filed: Jun. 19, 2002

(30) Foreign Application Priority Data
Dec. 26, 2001 (JP) 2001-393907

(51) Int. Cl. H04J 14/02

(52) U.S. Cl. 370/395.53; 370/420

(57) ABSTRACT

An Ethernet frame is transmitted through an optical communication channel connecting between a station apparatus and a subscriber resident apparatus. A transmission permission controlling unit of the station apparatus generates a transmission permission issuance controlling frame including an apparatus ID, sends it to the subscriber resident apparatus through an optical terminating unit. In the subscriber resident apparatus, a controlling unit checks if the received transmission permission issuance controlling frame is destined to the subscriber resident apparatus itself based on the apparatus ID. If the transmission permission issuance controlling frame is not destined to the subscriber resident apparatus itself, the subscriber resident apparatus does not perform any transmission, and if the transmission permission issuance controlling frame is destined to the subscriber resident apparatus itself, the subscriber resident apparatus sends an upward main signal. Therefore, the invention eliminates time-divisional control of the transmission.

### BACKGROUND OF THE INVENTION

1. Field of the Invention

The present invention relates to transmission technique for communicating with an Ethernet (registered trademark) frame, and in particular, an optical communication system employing shared access method in which an optical transmission medium is located between plural subscriber apparatuses and a station apparatus and shared among the plural subscriber apparatuses.

2. Description of the Related Art

Conventionally, in a subscriber optical communication system, in order to reduce the cost of optical fiber network and the cost of the interface at the station, the network employing PDS (passive double star) topology is used.

FIG. 8 shows a block diagram which explains a configuration of a system of an optical communication apparatus, its communication method, and a recording medium storing a control program for the optical communication method disclosed in the Japanese Unexamined Patent Publication No. Hei 11-98151.

In FIG. 8, an optical communication apparatus includes a station apparatus 111 and a subscriber resident apparatus 113. An outside workstation 112 is connected to the station apparatus 111, and a terminal 114 is connected to the subscriber resident apparatus 113.

The station apparatus 111 has a function enabling to dynamically change the band. Using this function, in a PDS system, redundant band obtained by subtracting the band for band guarantee service from the band between the subscriber resident apparatus 113 and the station apparatus 111 is shared among plural subscribers who join a band non-guarantee service.

The subscriber resident apparatus 113 includes a PDS terminating unit 131 terminating an interface with the opposing station apparatus 111, a terminal interface terminating unit 133 terminating non-guaranteed band service at the user side, a memory 132 converting the format between the PDS terminating unit 131 and the terminal interface terminating unit 133 and storing packet data, and a memory controlling unit 134 measuring data amount stored in the memory 132 and sending transmission request to the PDS terminating unit 131 when it becomes necessary to send a signal to the station apparatus side through the PDS terminating unit 131.

The station apparatus 111 includes a PDS terminating unit 121 terminating an interface with the opposing subscriber resident apparatus 113, a controlling unit 125 terminating control information from the outside workstation 112 and distributing control information required for each function block within the station apparatus, a subscriber information storing unit 124 storing information of subscribers who has applied to use shared band within the control information provided by the controlling unit 125, a packet analyzing unit 123 receiving the subscriber information from the subscriber information storing unit 124 and sending a subscriber ID and poling instruction to the PDS terminating unit 121, and a time-divisional switch (TSW) 122.

On sending the subscriber ID and the poling instruction to the PDS terminating unit 121, the packet analyzing unit 123 receives a transmission request 151 and the subscriber ID from the subscriber resident apparatus 113, and the packet analyzing unit 123 transmits a transmission permission signal 152 for upward shared band, which is shared using the above function, to the subscriber resident apparatus 113, and receives a packet signal from the subscriber resident apparatus 113. The packet analyzing unit 123 analyzes a packet length signal written in a packet over head (LLC part) of an initial packet signal from the subscriber resident apparatus 113, determines time to be occupied by the subscriber resident apparatus 113 according to the packet length, transmits a transmission permission signal 152 of an occupation time to the subscriber resident apparatus 113, and receives the packet signal from the subscriber resident apparatus 113.

Conventionally, a basic band is time-divisionally assigned to each subscriber resident apparatus, when the station apparatus assigns a transmission band for upward main signal to multiple subscriber resident apparatuses, the station apparatus sends the subscriber ID information and the poling instruction information to an arbitrary subscriber resident apparatus, receives the transmission request information and the subscriber ID information from the subscriber resident apparatus, sends the transmission permission signal to the subscriber resident apparatus when the transmission request is received, and receives the packet signal from the subscriber resident apparatus. The packet analyzing unit of the station side analyzes the packet length signal written in the packet overhead (LLC part) of the initial packet signal from the subscriber resident apparatus, determines the occupation time for the subscriber resident apparatus according to the packet length, sends the transmission permission signal of the occupation time to the subscriber resident apparatus, and receives the packet signal from the subscriber resident apparatus. Further, to perform these control, the subscriber resident apparatus divides the packet signal into small subdivisions to transmit.

Thus, there is a problem that it is required for both of the station side and the subscriber resident side to complete the above complex processes.

### SUMMARY OF THE INVENTION

The present invention is provided to solve the foregoing problems. The invention aims to facilitate a complex transmission control peculiar to the PDS system, obtain an optical communication system which can be implemented at a low cost and adaptive to an Ethernet frame transmission. In particular, the invention aims to obtain an optical communication system adaptive to construction of an optical access system for massive subscribers.

According to the present invention, in an optical communication system having a station apparatus and multiple subscriber resident apparatuses connected to the station apparatus and sending/receiving data by optical communication between the station apparatus and the multiple subscriber resident apparatuses, the station apparatus selects a specific subscriber resident apparatus among the multiple subscriber resident apparatuses as a selected subscriber resident apparatus, generates transmission permission issuance information for issuing data transmission permission to the selected subscriber resident apparatus, and sends the transmission permission issuance information to the multiple subscriber resident apparatuses. Also in the optical communication system of the invention, each of the multiple subscriber resident apparatuses receives the transmission permission issuance information sent from the station apparatus, checks if the transmission permission issuance information is destined to a subscriber resident apparatus itself, sends predetermined data to the station apparatus as upward main data when the transmission permission issuance information is destined to the subscriber resident apparatus itself, and does not send any data to the station apparatus when the transmission permission issuance information is not destined to the subscriber resident apparatus itself.

According to another aspect of the present invention, in an optical communication method for sending/receiving data by optical communication between a station apparatus and multiple subscriber resident apparatuses, the station apparatus selects a specific subscriber resident apparatus among the multiple subscriber resident apparatuses as a selected subscriber resident apparatus, generates transmission permission issuance information for issuing data transmission permission to the selected subscriber resident apparatus, and sends the transmission permission issuance information to the multiple subscriber resident apparatuses. Also in the optical communication method of the invention, each of the multiple subscriber resident apparatuses receives the transmission permission issuance information sent from the station apparatus, checks if the transmission permission issuance information is destined to a subscriber resident apparatus itself, sends predetermined data to the station apparatus as upward main data when the transmission permission issuance information is destined to the subscriber resident apparatus itself, and does not send any data to the station apparatus when the transmission permission issuance information is not destined to the subscriber resident apparatus itself.

The station apparatus thus performs a simple transmission permission control so as to prevent the collision of the upward main signal sent from the subscriber resident apparatuses.

### BRIEF EXPLANATION OF THE DRAWINGS

A complete appreciation of the present invention and many of the attendant advantages thereof will be readily obtained as the same becomes better understood by reference to the following detailed description when considered in connection with the accompanying drawings, wherein:

FIG. 1 shows a configuration of an optical communication system according to the first embodiment;

FIG. 2 shows an example of subscriber information to be registered in a station apparatus according to the first embodiment;

FIG. 3 shows an example of configuration elements of a controlling frame according to the first embodiment;

FIG. 4 shows a sequence summarizing a communication method for an upward main signal according to the first embodiment;

FIG. 5 shows an example of a sequence of the communication method for the upward main signal and configuration elements of a controlling frame according to the fourth embodiment;

FIG. 6 shows an example of a sequence of the communication method for the upward main signal and configuration elements of a controlling frame according to the fifth embodiment;

FIG. 7 shows a configuration of an optical communication system according to the eighth embodiment; and

FIG. 8 shows a configuration of a conventional optical communication method.

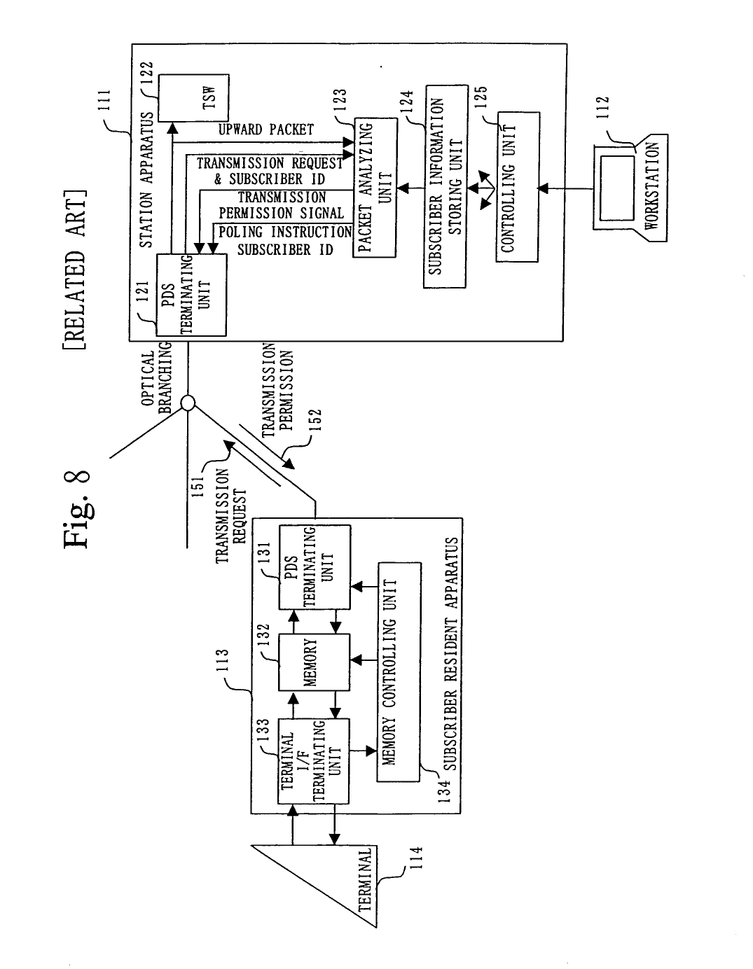

### DESCRIPTION OF THE PREFERRED EMBODIMENT

Embodiment 1.

Hereinafter, the first embodiment of the invention will be described.

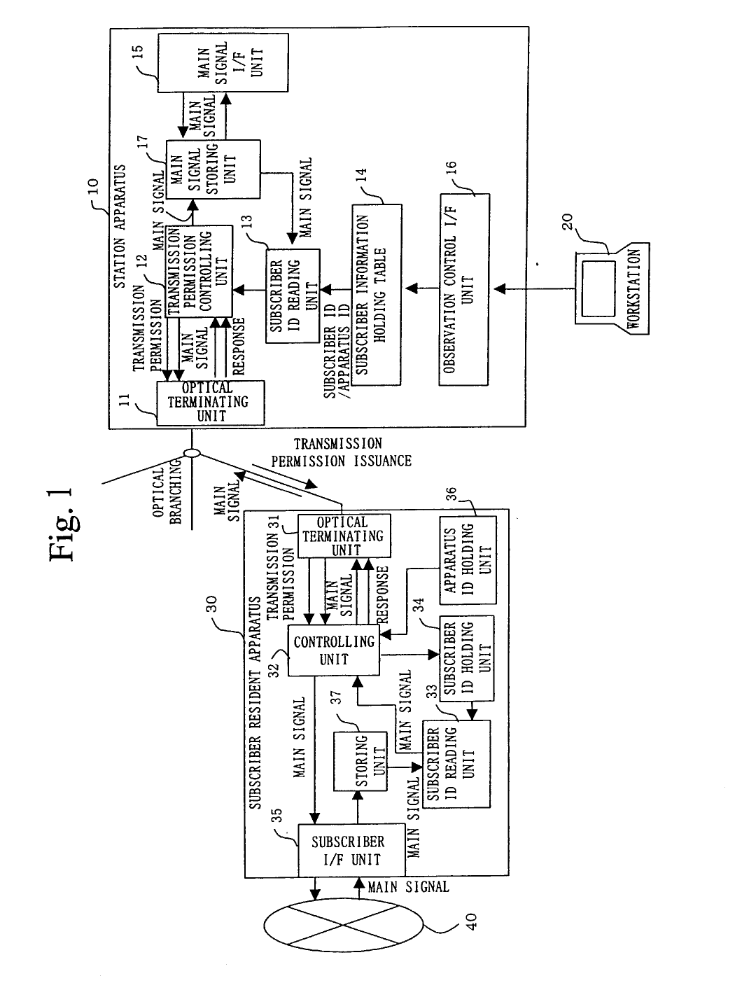

In FIG. 1, 10 shows a station apparatus which includes an optical terminating unit 11 performing optical/electric signal conversion, a transmission permission controlling unit 12 controlling to issue a transmission permission for an upward main signal (upward main data), a subscriber ID reading unit 13 reading a subscriber ID from an input main signal, a subscriber information holding unit 14 holding subscriber information which has been registered, a main signal interfacing unit 15 taking a main signal interface with an upper-grade apparatus, an observation control interfacing unit 16, and a main signal storing unit 17 temporarily storing downward main signal (downward main data).

An observation controlling apparatus 20 connected to the observation control interfacing unit 16 is, for example, a terminal device such as a workstation, which processes registration of the subscriber information in the station apparatus.

The main signal interfacing unit 15, is connected to an upper-grade apparatus which is not shown in the figure, transmits an upward main signal to the upper-grade apparatus, and receives a downward main signal. The upper-grade apparatus corresponds to a downward main data transmission apparatus.

A subscriber resident apparatus 30 includes an optical terminating unit 31 performing optical/electric signal conversion, a controlling unit 32 transmitting/receiving control information such as an issue of the transmission permission for the upward main signal with the station apparatus, a subscriber ID reading unit 33 reading a subscriber ID from an input downward main signal, a subscriber ID holding unit 34 holding the subscriber ID provided by the control information, a subscriber interfacing unit 35 connecting to a subscriber network 40, an apparatus ID holding unit 36 holding a predetermined apparatus ID, and a storing unit 37 temporarily storing the upward main signal.

Here, the upward main signal and the downward main signal are Ethernet frames.

The apparatus ID is identification information set in the subscriber resident apparatus.

Further, the subscriber ID is identification information of the subscriber network 40 connected to each of the subscriber resident apparatus 30. This subscriber ID can be destination information which has been previously embedded in the main signal (Ethernet frame), namely, a MAC (media access control) address, IP (internet protocol) address, VLAN (virtual local-area-network) tag, etc., and further, the subscriber ID can be the apparatus ID itself.

An operation will be explained in the following.

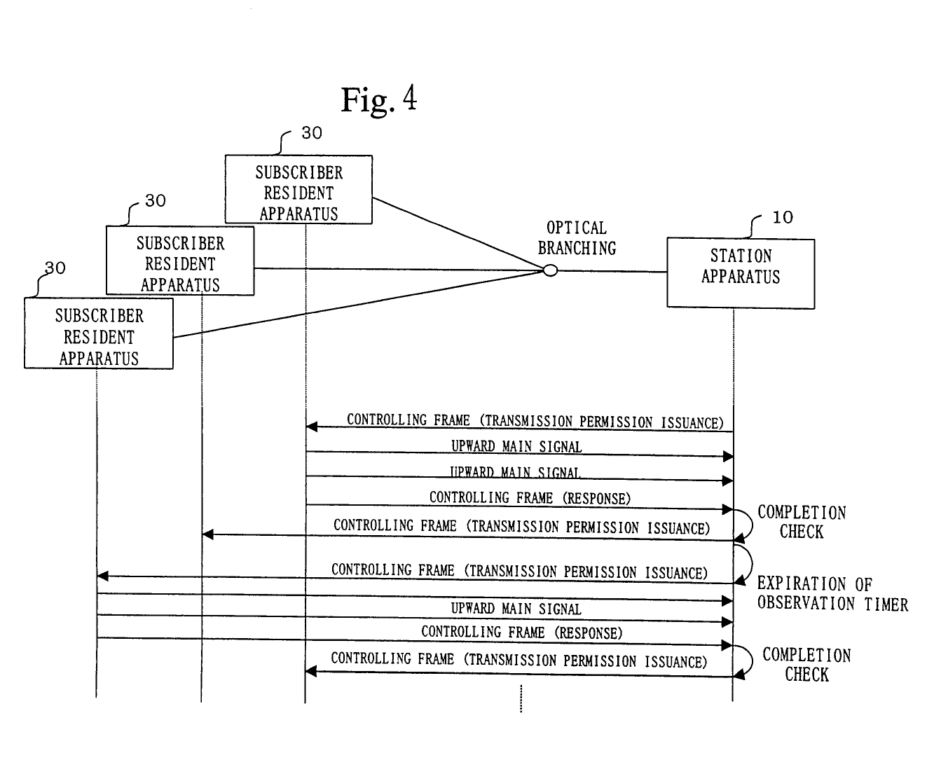

FIG. 4 shows how to control the transmission permission for the upward main signal.

Multiple subscriber resident apparatuses 30 are connected to the station apparatus 10, and the station apparatus 10 issues the transmission permission to these subscriber resident apparatuses 30 sequentially by sending a controlling frame with Round-Robin method. Here, the controlling frame issuing the transmission permission is referred to as a transmission permission issuance controlling frame. Further, the transmission permission issuance controlling frame corresponds to transmission permission issuance information.

The subscriber resident apparatus 30 to which the transmission permission is provided by the transmission permission issuance controlling frame transmits the upward main signal. The subscriber resident apparatus 30 never transmits any signal, even control signal, until the transmission permission is issued by the transmission permission issuance controlling frame. With this function, time-divisional control of the transmission request signal, which has been necessary in a conventional technique, becomes unnecessary.

When the subscriber resident apparatus 30 finishes transmitting the upward main signal, the controlling frame notifying transmission completion is sent. Here, the controlling frame notifying the transmission completion is referred to as transmission response controlling frame. Further, the transmission response controlling frame corresponds transmission completion information.

On receiving the transmission response controlling frame, the station apparatus 10 issues the transmission permission to the next subscriber resident apparatus 30.

The station apparatus 10 is provided with an observation timer. The station apparatus 10 activates the observation timer on transmitting the transmission permission issuance controlling frame, observes if the upward main signal from the subscriber resident apparatus 30 is received or not. When the main signal is not received until the time set in the observation timer expires, the expiration of the observation timer triggers to issue the transmission permission to the next subscriber resident apparatus 30.

Next, the controlling frame will be explained.

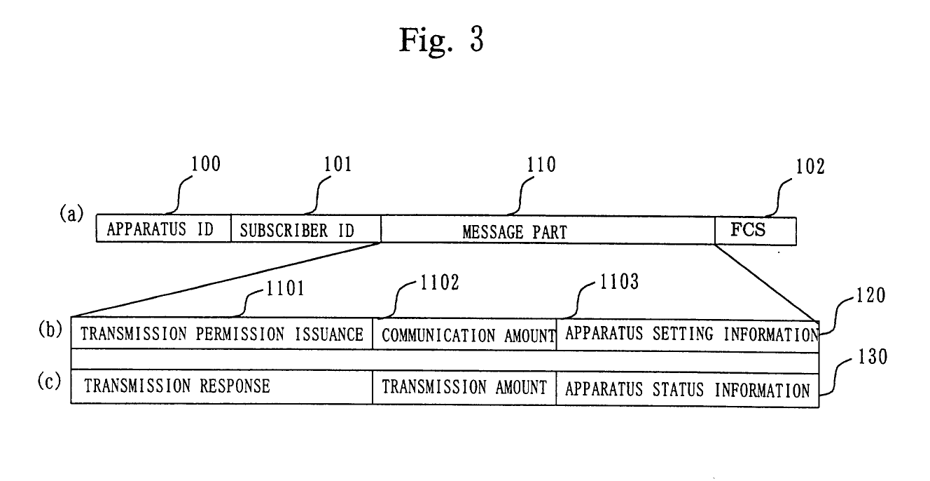

The controlling frame is a frame of which a format is changed so as not to be mixed with the upward main signal and the downward main signal of the Ethernet frame. The controlling frame is, for example, configured as shown by (a) in FIG. 3. The controlling frame includes an apparatus ID 100 indicating the subscriber resident apparatus of the destination, a subscriber ID 101 making correspondence between the main signal and the subscriber resident apparatus of the destination, a message part 110, and an FCS (Frame check sequence) for detection of a transmission error of the controlling frame.

There are two types of the controlling frames; a transmission permission issuance controlling frame 120 shown by (b) in FIG. 3, and a transmission response controlling frame 130 shown by (c) in FIG. 3. These controlling frames are configured by a command part 1101, a parameter part 1102, and an information part 1103, and elements such as shown in FIG. 3 are set in each of the parts.

Here, apparatus set information means information to be set in the subscriber resident apparatus as an operation mode of the subscriber resident apparatus, and apparatus status information means information showing status such as normal/abnormal status of the transmission channel, the apparatus itself, viewing from the subscriber resident apparatus side, at transmitting time of the transmission response controlling frame.

Although FIG. 3 shows communication amount, transmission amount as the parameter part 1102, these elements will be explained in the sixth embodiment, and it is assumed that the controlling frame of the present embodiment does not include the parameter part 1102 showing the communication amount and the transmission amount.

The foregoing has summarized the operation, and the following will explain a detailed mechanism in reference to FIG. 1.

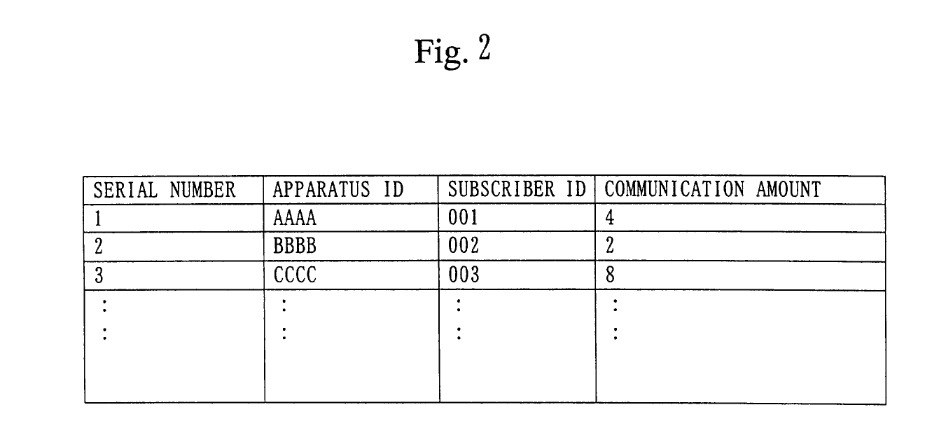

The subscriber information is supplied from the observation controlling apparatus 20 to the station apparatus 10 through the observation control interfacing unit 16. The supplied subscriber information includes, for example, the subscriber ID and the apparatus ID as shown in FIG. 2, and the subscriber information is held by the subscriber information holding table 14. FIG. 2 shows items for the communication amount, however, the communication amount will be explained in the sixth embodiment, and it is assumed that the subscriber information does not include the items for communication amount according to the present embodiment.

The transmission permission controlling unit 12 searches the apparatus ID registered in the subscriber information holding table 14 and selects the subscriber resident apparatus 30 to issue the transmission permission and generates the transmission permission issuance controlling frame (FIG. 3) including the apparatus ID of the selected subscriber resident apparatus 30 and the subscriber ID which should be paired with the apparatus ID. The transmission permission controlling unit 12 transmits the generated transmission permission issuance controlling frame to the optical transmission channel through the optical terminating unit 11. The subscriber resident apparatus 30 selected by the transmission permission controlling unit 12 is called a selected subscriber resident apparatus.

The above generation and transmission of the transmission permission issuance controlling frame is usually processed while the downward main signal is not being received from the upper-grade apparatus. However, a case may occur in which the downward main signal is received from the upper-grade apparatus during the generation and transmission of the transmission permission issuance controlling frame. In this case, the downward main signal input from the main signal interfacing unit 15 is temporarily stored in the main signal storing unit 17 until the transmission of the transmission permission issuance controlling frame is finished.

The transmission permission issuance controlling frame sent from the station apparatus 10 is sent to multiple subscriber resident apparatus 30, and the multiple subscriber resident apparatus 30 receive transmission permission issuance controlling frame respectively and simultaneously.

Each subscriber resident apparatus 30 checks if the apparatus ID within the transmission permission issuance controlling frame and the apparatus ID stored in the apparatus ID holding unit 36 match, and the subscriber resident apparatus 30 receives the transmission permission issuance controlling frame if they match, and the subscriber resident apparatus 30 discards the transmission permission issuance controlling frame if they don't match.

The subscriber resident apparatus 30 which receives the transmission permission issuance controlling frame stores the subscriber ID if the subscriber ID is indicated in the transmission permission issuance controlling frame. When the apparatus ID is used for the subscriber ID, the apparatus ID holding unit 36 already stores the apparatus ID, so that storing the apparatus ID at this stage becomes unnecessary.

The subscriber resident apparatus 30 which receives the subscriber ID receives the downward main signal from the optical terminating unit 31 when the station apparatus 10 transmits the downward main signal, and at the same time, the subscriber resident apparatus 30 checks if the received downward main signal is destined to the subscriber resident apparatus 30 itself based on the subscriber ID held in the subscriber ID holding unit 34.

The downward main signal from the station apparatus 10 is sent to all of multiple subscriber resident apparatus 30, and the downward main signal contains the subscriber ID. Accordingly, each subscriber resident apparatus 30 checks the subscriber ID included in the received downward main signal and the subscriber ID held in the subscriber ID holding unit 34 match or not using the subscriber ID reading unit 33. If they match, the subscriber resident apparatus 30 outputs the downward main signal to the subscriber interfacing unit 35, and the subscriber resident apparatus 30 discards the downward main signal if they don't match.

When the apparatus ID is used for the subscriber ID, the downward main signal contains the apparatus ID. In the subscriber resident apparatus 30, the subscriber ID reading unit 33 checks the apparatus ID held in the apparatus ID holding unit 36 and the apparatus ID included in the downward main signal and judges the downward main signal is destined to the subscriber resident apparatus 30 itself or not.

The upward main signal received by the subscriber resident apparatus 30 from the subscriber network 40 through the subscriber interfacing unit 35 is first stored in the storing unit 37 until the transmission permission issuance controlling frame is received from the station apparatus.

If at least one frame of the upward main signal is stored in the storing unit 37 when the transmission permission issuance controlling frame is received, the stored upward main signal is extracted, and the subscriber ID included in the stored upward main signal is checked by the subscriber ID reading unit 33. If the subscriber ID is not contained in the upward main signal, the subscriber ID held in the subscriber ID holding unit 34 is appended to the upward main signal to transmit to the optical terminating unit 31. If the subscriber ID is included in the received upward main signal but does not match the subscriber ID held in the subscriber ID holding unit 34, the upward main signal is discarded.

When the apparatus ID is used for the subscriber ID, the subscriber resident apparatus does not check the subscriber ID, but appends the apparatus ID held in the apparatus ID holding unit to transmit to the station apparatus.

After transmitting the upward main signal, the subscriber resident apparatus 30 then sends the transmission response controlling frame by the controlling unit 32. When there is no upward main signal to be transmitted, the subscriber resident apparatus 30 also sends the transmission response controlling frame.

The upward main signal is sent to the transmission permission controlling unit 12 through the optical terminating unit 11, and the transmission permission controlling unit 12 sends the received upward main signal further to the main signal interfacing unit 15. At this time, the subscriber ID reading unit 13 reads the subscriber ID included in the upward main signal and checks if the read subscriber ID and the subscriber ID embedded in the transmission response controlling frame, which has been sent to the subscriber resident apparatus 30, match. If they don't match, the upward main signal is discarded. On the other hand, if they match, the upward main signal is transmitted to the upper-grade apparatus through the main signal interfacing unit 15.

When the apparatus ID is used for the subscriber ID, the station apparatus checks if the apparatus ID appended to the received main signal and the apparatus ID of the subscriber resident apparatus to which is the transmission permission is issued, match, and if they don't match, the received main signal is discarded. On the other hand, if they match, the apparatus ID is removed from the upward main signal, and the upward main signal is sent to the upper-grade apparatus through the main signal interfacing unit 15.

The transmission permission controlling unit 12 receives the transmission response controlling frame and recognizes completion of the upward main signal transmission. The transmission permission controlling unit 12 searches the apparatus ID registered in the subscriber information holding table 14 again, selects the subscriber resident apparatus 30 to which the transmission permission will be issued, generates the transmission permission issuance controlling frame including a pair of the apparatus ID of the selected subscriber resident apparatus 30 and the subscriber ID, and sends the transmission permission issuance controlling frame to the selected subscriber resident apparatus. By this operation, the transmission permission is issued to the next subscriber resident apparatus which is connected to the network.

Here, on sending the transmission permission issuance controlling frame, the transmission permission controlling unit 12 activates the observation timer, and the transmission permission will be issued to the next subscriber resident apparatus if the transmission permission controlling unit 12 doesn't receive any signal within the time period set by the timer.

As discussed above, in the optical communication system according to the present embodiment, the Ethernet frame is transmitted on the optical communication channel which connects the station apparatus and the subscriber resident apparatus. When multiple subscriber resident apparatuses are connected to the optical interface of the station apparatus, the controlling frame having a different format from the subscriber main signal so as not to be mixed with the subscriber main signal is sent for controlling the timing of sending the upward main signal of the subscriber resident apparatus from the station apparatus. The subscriber resident apparatus receives this frame and starts sending the upward main signal without sending back the transmission request.

The subscriber resident apparatus does not send any signal including the control signal until the transmission permission is obtained, which eliminates time-divisional control in the communication system.

Further, according to the optical communication system of the present embodiment, the information which has been previously embedded in the Ethernet frame such as the MAC address, VLAN tag, etc. is used as the subscriber ID. A pair of the apparatus ID, which has been previously assigned to each subscriber resident apparatus, and the subscriber ID is managed, and the transmission/receipt can be controlled by the apparatus ID of the destined subscriber resident apparatus obtained from the received subscriber main signal. Therefore, the optical communication system can operate in the same manner as transmitting/receiving the Ethernet (frame).

As has been described, the station apparatus performs a simple transmission permission control so as to prevent the collision of the upward main signal sent from the subscriber resident apparatuses, and the subscriber resident apparatus has an internal unit for discarding an unnecessary signal using the subscriber ID embedded in the main signal so that the main signal can be controlled not to send to the subscriber other than the destined subscriber. Therefore, the optical communication system suitable for configuring the subscriber optical access system can be embodied.

Embodiment 2.

In the first embodiment, when the upward main signal does not include the subscriber ID, the subscriber resident apparatus 30 embeds the subscriber ID in the main signal so that the upward main signal sent to the station apparatus always includes the subscriber ID. Instead of processing the subscriber main signal, the subscriber resident apparatus generates the controlling frame (transmission start controlling frame) notifying the start of transmitting the upward main signal before transmitting the first upward main signal, namely, just after receiving the transmission permission issuance controlling frame. The subscriber resident apparatus embeds the subscriber ID in the generated transmission start controlling frame and send the transmission start controlling frame with the subscriber ID embedded. At this time, the subscriber resident apparatus does not have to check if the subscriber ID has been embedded in the upward main signal, and the subscriber resident apparatus always embeds the subscriber ID held in the subscriber ID holding unit in the transmission start controlling frame. By this operation, the subscriber resident apparatus sends the subscriber ID embedded in the controlling frame similar to the transmission response controlling frame which will be sent after sending the subscriber main signal. The transmission start controlling frame corresponds to transmission start information.

The station apparatus 10 receives the upward main signal sent by the subscriber resident apparatus 30 inserted between the transmission start controlling frame and the transmission response controlling frame. The station apparatus 10 checks if the subscriber ID included in the transmission start controlling frame and the transmission response controlling frame match the subscriber ID embedded in the transmission permission issuance controlling frame. If they match, the whole upward main signal, which has been inserted between the transmission start controlling frame and the transmission response controlling frame, is transferred to the upper-grade apparatus, and if they don't match, the whole upward main signal inserted can be discarded.

Embodiment 3.

In the foregoing first and second embodiments, an example cases were shown in which the upward main signal is always sent to the station apparatus with the subscriber ID as a result. Another embodiment will be explained in which the destination can be specified by learning the relation between the apparatus ID and the destination specifying information and the sender specifying information which have been previously set in the main signal, without using the subscriber ID. Hereinafter, the embodiment will be explained in which, for example, the MAC address is used.

On receiving the upward main signal from the subscriber resident apparatus 30, the transmission permission controlling unit 12 of the station apparatus 10 stores the sender's MAC address included in the upward main signal and the apparatus ID of the subscriber resident apparatus 30 to which the transmission permission is issued most recently, and transfers the received upward main signal to the upper-grade apparatus as described in the first embodiment.

On receiving the downward main signal from the upper-grade apparatus through the main signal interfacing unit 15, the transmission permission controlling unit 12 of the station apparatus 10 compares the stored MAC address and the MAC address of the destination included in the downward main signal. If they match, the stored apparatus ID of the subscriber resident apparatus 30 is extracted. A scrambler, which is not shown in the figure, scrambles the downward main signal based on the extracted apparatus ID, and the scrambled downward main signal is sent to the subscriber resident apparatus 30.

The multiple subscriber resident apparatuses 30 receive the scrambled downward main signal, respectively, and a descrambler of each subscriber resident apparatus, which is not shown in the figure, descrambles the received scrambled downward main signal using the apparatus ID of each subscriber resident apparatus. Each subscriber resident apparatus can recognize whether to transfer or discard the downward main signal by checking FCS of the descrambled result. Accordingly, if an error is detected in the FCS of the descrambled result, the received downward main signal is to be discarded, and if no error is found, the received downward main signal is to be transferred to the subscriber network 40.

By the above configuration, the transmission can be performed to a specific destination without adding the subscriber ID to the main signal.

Embodiment 4.

In the foregoing first embodiment, the transmission permission is issued serially to each of the multiple subscriber resident apparatuses connected to one station apparatus, and each subscriber resident apparatus sends the apparatus status information by including the apparatus status information in the transmission response controlling frame after transmitting the upward main signal when the transmission permission is issued (refer to FIG. 3). Here, the apparatus status information is, for example, the information relating to linking status of the communication channel and so on, as described above. However, it is sometimes preferable in transmission efficiency to give the transmission permission for transmission of the apparatus status information simultaneously to multiple subscriber apparatuses using one controlling frame, because real time collection of the apparatus status information is required and further a signal length of the apparatus status information is quasi-fixed.

Therefore, the present embodiment will describe a case in which the transmission permission is issued for transmitting the apparatus status information independently from the transmission permission for the upward main signal.

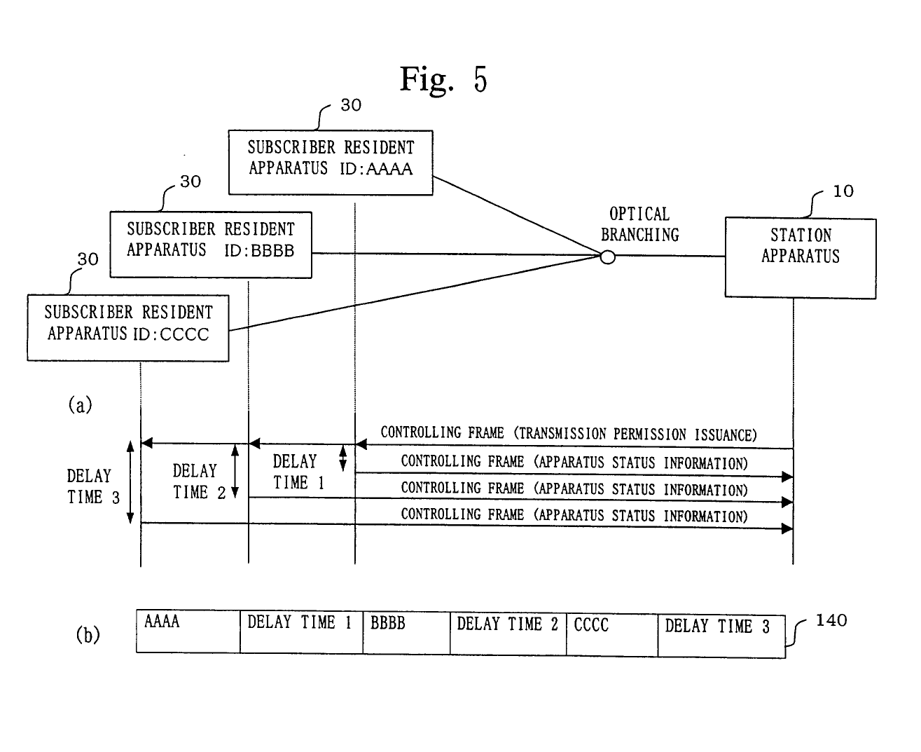

In the present embodiment, for instance, a controlling frame (apparatus status information requesting frame) 140 for requesting the transmission of the apparatus status information is sent to multiple subscriber resident apparatuses (the apparatus ID: AAAA, the apparatus ID: BBBB, and the apparatus ID: CCCC) as shown in (b) of FIG. 5. A predetermined delay time is specified in the apparatus status information requesting frame for each subscriber resident apparatus. As shown in (b) of FIG. 5, the delay time 1 is specified for the subscriber resident apparatus having the apparatus ID: AAAA, the delay time 2 is specified for the subscriber resident apparatus having the apparatus ID: BBBB, and the delay time 3 is specified for the subscriber resident apparatus having the apparatus ID: CCCC, respectively.

When the apparatus status information requesting frame is sent from the station apparatus 10, the multiple subscriber resident apparatuses receive the apparatus status information requesting frame 140 simultaneously. And then, as shown in (a) of FIG. 5, each subscriber resident apparatus sends the controlling frame including the apparatus status information of each subscriber resident apparatus itself to the station apparatus 10 after the corresponding predetermined delay time passes.

The apparatus status information requesting frame corresponds to a apparatus status information request.

In another way, the transmission of the apparatus status information requesting frame can be performed by the transmission permission controlling unit 12 when a periodical timer provided within the transmission permission controlling unit 12 of the station apparatus 10 terminates. Or the transmission of the apparatus status information requesting frame can be performed by the transmission permission controlling unit 12 with an instruction from the observation controlling unit 20. On starting the transmission of the apparatus status information requesting frame, if the downward main signal is being sent, the transmission permission controlling unit 12 places the apparatus status information requesting frame just after the final frame of the downward main signal in transmission queue.

In the first embodiment, since each subscriber resident apparatus sends the apparatus status information included in the transmission response controlling frame after transmitting the upward main signal, the collection of the apparatus status information is delayed or can be extremely delayed according to the time required for the transmitting the upward main signal consisting of signals having variable length. The present embodiment enables to minimize this delay and further enables to collect real-time information.

Embodiment 5.

The fifth embodiment will be explained, in which the configuration of the fourth embodiment is modified.

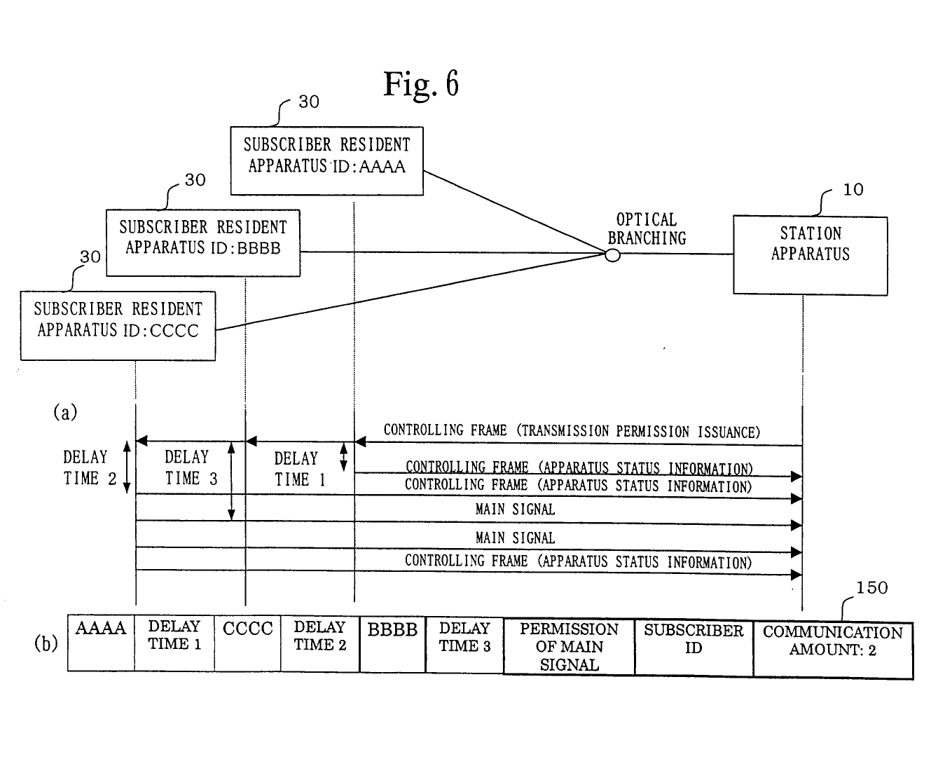

In the present embodiment, as shown in (b) of FIG. 6, the station apparatus sends a transmission permission issuance controlling frame with request (transmission permission issuance information with request) 150, which is formed by combining the transmission permission issuance controlling frame shown in the first embodiment and the apparatus status information requesting frame shown in the fourth embodiment. In an example shown in (b) of FIG. 6, the delay time 1 is assigned to the subscriber resident apparatus having the apparatus ID: AAAA, the delay time 2 is assigned to the subscriber resident apparatus having the apparatus ID: CCCC, and the delay time 3 is assigned to the subscriber resident apparatus having the apparatus ID: BBBB. Further, the transmission permission for the upward main signal is issued to the subscriber resident apparatus having the apparatus ID: BBBB.

The subscriber resident apparatuses to which only transmission of the apparatus status information is allowed (the subscriber resident apparatuses having the apparatus ID: AAAA and the apparatus ID: CCCC in the example of FIG. 6) sends the controlling frame including only the apparatus status information after a predetermined delay time passes. The subscriber resident apparatus to which the transmission of the upward main signal is allowed (the subscriber resident apparatus having the apparatus ID: BBBB in the example of FIG. 6) sends the upward main signal and then sends the transmission response controlling frame including the apparatus status information.

By the above operation, the transmission permission for the main signal is issued and the apparatus status information can be collected at the same time, quasi-fixed length data (apparatus status information) and variable length data (upward main signal) can be sent at once, which improves transmission efficiency.

Embodiment 6.

In connection with the issuance of the transmission permission for the upward main signal to the subscriber resident apparatus, it is desirable to issue the transmission permission to multiple subscriber resident apparatuses rotationally in a short period from a view point of evenness of the service. On the other hand, it is desirable to make the subscriber resident apparatus send the upward main signal as many as possible at once, so that vacant time of the network can be reduced, which improves the transmission efficiency.

According to the present embodiment, at the time of issuance of the transmission permission, the communication amount available to each subscriber resident apparatus at once is specified by, for example, the number of frames, which makes the issuance of the transmission permission well-balanced between the evenness and the transmission efficiency.

According to the present embodiment, as shown in FIG. 2, the subscriber information includes information related to the communication amount permitted for each subscriber (transmission permitted data amount), and such subscriber information including the communication amount is sent to the station apparatus 10 from the observation controlling unit 20. The subscriber information including the communication amount is held by a subscriber information holding table 14, and the transmission permission controlling unit 12 generates the transmission permission issuance controlling frame specifying the communication amount based on the registered information of the communication amount and sends the transmission permission issuance controlling frame to the subscriber resident apparatus.

The subscriber resident apparatus counts the data amount of upward main signal accumulated in an accumulating unit 37. If the received transmission permission issuance controlling frame is destined to the subscriber resident apparatus itself, the accumulated upward main signals are continuously sent within the communication amount specified by the transmission permission issuance controlling frame. Namely, when the data amount of the accumulated upward main signals is less than the specified communication amount, the whole accumulated upward main signal is sent at once, and when the data amount of the accumulated upward main signals is equal to or greater than the specified communication amount, the upward main signal is sent up to the specified communication amount. And further, the transmission response controlling frame is sent after sending the upward main signal.

Further, it is acceptable to allocate greater communication amount to a specific subscriber resident apparatus.

As described above, according to the optical communication system of this embodiment, the permitted communication amount is previously determined by the number of frame and allocated to the subscriber resident apparatus from the station apparatus, which eliminates packet analysis, measurement of the occupation time of the band, and synchronous control between the station apparatus and the subscriber resident apparatus which requires for controlling by the time.

Embodiment 7.

In the sixth embodiment, the subscriber resident apparatus to which the transmission permission is issued recognizes the frame amount accumulated in the storing unit 37 and controls the continuous transmission amount. In another way, the subscriber resident apparatus can start sending the main signal without recognizing the accumulated amount.

In this case, as the controlling unit 32 transfers the upward main signal which is continuously received from the storing unit 37 or the subscriber interfacing unit 35, the controlling unit 32 detects an interframe gap (idle status) within the upward main signal which is being transferred. The controlling unit 32 sends the main signal continuously until detecting the gapping time which exceeds a predetermined time, or up to the communication amount specified above.

Namely, the subscriber interfacing unit 35 receives the upward main signal which is divided for each predetermined frame (unit data) from the subscriber network 40, and a predetermined gapping time may be generated between the frames at the time when the subscriber interfacing unit 35 receives each frame. Accordingly, the controlling unit 32 measures the gapping time generated between the frames on transferring each frame to an optical terminating unit 31, and when the gapping time which exceeds the predetermined time is detected, it can be judged that all frames of the upward main signal have been transferred to the optical terminating unit 31.

Embodiment 8.

In the first embodiment, the station apparatus 10 stores the downward main signal, which is received from the upper-grade apparatus during the transmission permission issuance controlling frame is transmitted, in the main signal storing unit 17, and the subscriber resident apparatus 30 stores the upward main signal, which is received from the subscriber network 40 before the transmission permission issuance controlling frame is received or during the transmission response controlling frame is transmitted, in the storing unit 37.

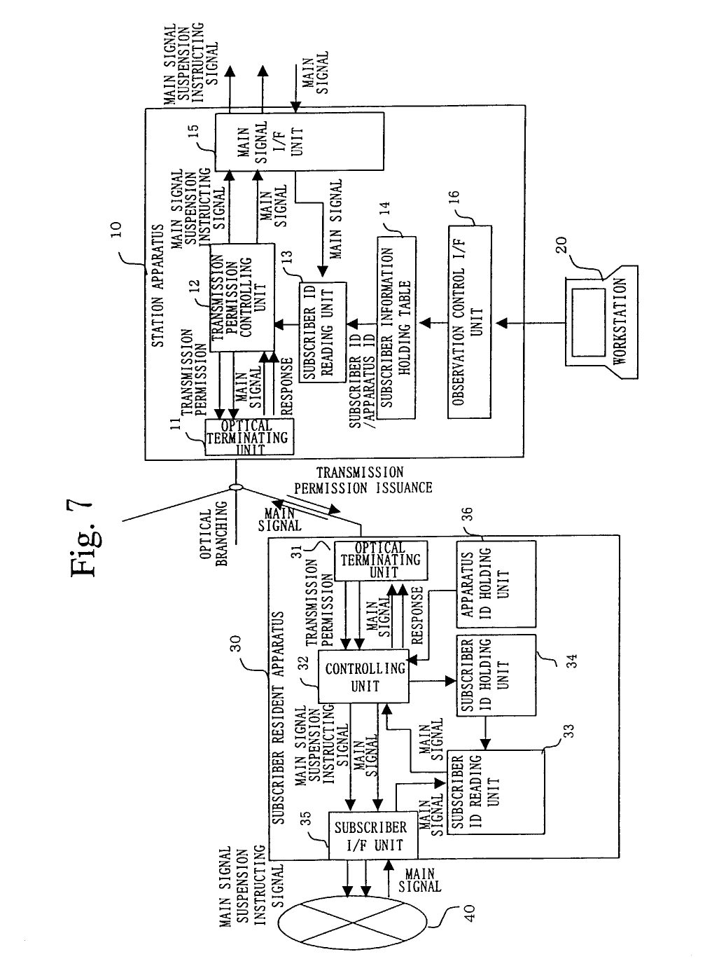

According to the present embodiment, as shown in FIG. 7, a signal is generated from the main signal interfacing unit 15 and the subscriber interfacing unit 35 for suspending the transmission of the main signal. Concretely, while the transmission permission controlling unit 12 sends the transmission permission issuance controlling frame, while the controlling unit 32 sends the transmission response controlling frame, and while the controlling unit 32 waits for the issuance of the transmission permission, the transmission permission controlling unit 12 or the controlling unit 32 outputs a signal showing the above status (a main signal suspension instructing signal which instructs to suspend the transmission of the downward main signal or the upward main signal) to each of the main signal interfacing unit 15 and the subscriber interfacing unit 35. And the main signal interfacing unit 15 or the subscriber interfacing unit 35 outputs the main signal suspension instructing signal to the upper-grade apparatus or the subscriber network 40 to suspend the transmission of the main signal.

By this operation, the main signal storing unit 17 or the storing unit 37 can be eliminated, or at least it can be simplified into the storing unit of less capacity.

The upper-grade apparatus or the subscriber network which inputs the main signal suspension instructing signal sends the main signal to a circuit block, which is not within a scope of the present invention and located outside the main signal interfacing unit 15 and the subscriber interfacing unit 35 or apparatuses connected outside the optical communication system of the present invention. The main signal is obstructed by the circuit block or the apparatuses, stagnated and accumulated.

Embodiment 9.

In a configuration in which only a single subscriber resident apparatus is connected to one station apparatus, the station apparatus and the subscriber resident apparatus are provided with a bypass route which stops the operation described in the first through eighth embodiments. The control of the transmission can stop by switching to the bypass route, which improves the transmission efficiency of the main signal.

In this case, the station apparatus can send the controlling frame including an identifier instructing to switch to the bypass route, and the subscriber resident apparatus can switch to the bypass route based on the identifier included in the controlling frame.

Embodiment 10.

The station apparatus and the subscriber resident apparatus described in the first through ninth embodiments can be implemented by a hardware circuit having each configuration element described in the first through ninth embodiments, and further, a part of the hardware circuit can be implemented by a software control. In case of implementing the software control, a configuration is made by a control program, in which the operation of each configuration element is replaced by a process, its recording medium, and a central processing unit (CPU).

In the foregoing first through tenth embodiments, the optical communication system of the invention has been described, and further, an optical communication method can be implemented according to the operation procedure described in the first through tenth embodiments.

Hereinafter, the characteristics of the optical communication system explained in the foregoing embodiments will be summarized.

According to the first embodiment, in an optical communication system, optical communication is performed through an optical transmission medium set between multiple subscriber resident apparatuses and a station apparatus and shared by the multiple subscriber resident apparatuses, the optical communication system includes:

the station apparatus having a unit for issuing a transmission permission to the subscriber resident apparatus by sending an apparatus ID which is previously set in the subscriber resident apparatus based on predetermined subscriber information, and a unit for detecting completion of transmission of a subscriber main signal sent from the subscriber resident apparatus to which the transmission permission is issued and issuing the transmission permission to another subscriber resident apparatus; and

the subscriber resident apparatus having a unit for receiving the transmission permission, a unit for setting the apparatus ID, and a unit for checking the apparatus ID, and

the subscriber resident apparatus does not send any signal until the effective transmission permission destined to the subscriber resident apparatus itself is received.

According to the first embodiment, in the optical communication system, transmission of the subscriber main signal is performed between the multiple subscriber resident apparatuses and the station apparatus through the optical communication medium, and control information for each subscriber resident apparatus is sent/received as a controlling frame through the optical communication medium,

both of the station apparatus and each subscriber resident apparatus include a unit for detecting an interframe gap of the subscriber main signal and starting to send the controlling frame during the gapping period and a unit for temporarily storing the subscriber main signal subsequent to the controlling frame during the controlling frame is being sent.

According to the first embodiment, the optical communication system includes:

the station apparatus having a unit for issuing the transmission permission to the subscriber resident apparatus by sending the apparatus ID which is previously set in the subscriber resident apparatus and a subscriber ID which is previously set for each subscriber; and

the subscriber resident apparatus having a unit for receiving the transmission permission, a unit for setting the apparatus ID, a unit for checking the apparatus ID, a unit for holding the subscriber ID, and a unit for relaying the subscriber main signal with inserting or rewriting the subscriber ID in the subscriber main signal.

According to the optical communication system of the first embodiment, the station apparatus includes a unit for receiving the apparatus ID embedded in a transmission response, and a unit for relaying the subscriber main signal along with checking the subscriber ID embedded in the subscriber main signal sent from the subscriber resident apparatus, judging if a set of the apparatus ID and the subscriber ID to which the transmission is permitted matches the registered information.

According to the optical communication system of the first embodiment, the station apparatus includes a unit for checking if the effective subscriber main signal is received or not after the station apparatus issues the transmission permission, and an observation timer suspending the check of the subscriber main signal and issuing the transmission permission to a next subscriber resident apparatus.

According to the first embodiment, the optical communication system includes:

the subscriber resident apparatus having a unit for sending a controlling frame which shows completion of transmission of the subscriber main signal subsequent to sending the subscriber main signal after the transmission permission is obtained, and

the station apparatus having a unit for issuing the transmission permission to a next subscriber resident apparatus when the controlling frame is received.

According to the optical communication system of the second embodiment, the subscriber resident apparatus, to which the transmission permission is issued, includes a unit for inserting the apparatus ID of the subscriber resident apparatus or the subscriber ID in response to the transmission permission and sending the response before sending the subscriber main signal, and

the station apparatus, which receives the response, includes a unit for checking if the apparatus ID or the subscriber ID in the response matches the apparatus ID or the subscriber ID to which the transmission permission is issued.

According to the optical communication system of the third embodiment, the station apparatus includes a unit for holding the apparatus ID which is previously set in the subscriber resident apparatus and the subscriber ID which is previously set for each subscriber resident apparatus and embedded in the subscriber main signal, and a unit for reading the subscriber ID in the subscriber main signal on sending the subscriber main signal to the subscriber resident apparatus, checking the read subscriber ID with the subscriber ID held, and searching the apparatus ID of the subscriber resident apparatus which is destination of the subscriber main signal.

According to the optical communication system of the fourth and fifth embodiments, the station apparatus includes a unit for simultaneously issuing the transmission permission to multiple subscriber resident apparatuses connected to the station apparatus, and each subscriber resident apparatus, which obtains the transmission permission, include a unit for sequentially sending a signal after a delay time specified for each subscriber resident apparatus.

According to the sixth embodiment, the optical communication system includes:

the station apparatus having a unit for issuing the transmission permission with permitted communication amount based on the subscriber information which is previously set; and

the subscriber resident apparatus having a unit for temporarily storing the subscriber main signal until the transmission permission is obtained, and continuously sending the subscriber main signal within the permitted communication amount.

According to the optical communication system of the seventh embodiment, the subscriber resident apparatus includes a unit for relaying the subscriber main signal along with measuring an interframe gap among the subscriber main signal sent from the subscriber network, and a unit for continuously sending the subscriber main signal until the gapping time exceeds a predetermined time, or the communication amount reaches the permitted communication amount issued with the transmission permission.

According to the eighth embodiment, in the optical communication system, transmission of the subscriber main signal is performed between the multiple subscriber resident apparatuses and the station apparatus through the optical communication medium, and control information for each subscriber resident apparatus is sent/received as a controlling frame through the optical communication medium,

both of the station apparatus and each subscriber resident apparatus include a unit for detecting an interframe gap of the subscriber main signal and starting to send the controlling frame during the gapping period, and a unit for suspending the subsequent subscriber main signal while the controlling frame is being transmitted, which eliminates or lessens the storing unit for temporarily storing the subscriber main signal.

According to the ninth embodiment, in the optical communication system, both of the station apparatus and the subscriber resident apparatus include a unit for sending the subscriber main signal or the controlling frame at an arbitrary timing without performing the process of the first through eighth embodiments based on the subscriber information which is previously registered.

As discussed above, according to the present invention, collision of the upward main signals can be avoided by a simple mediation of the transmission permission. Therefore, the invention provides an advantage to accomplish PDS control in a low cost by combining the present invention with a commonly marketed component for Ethernet. Further, the even distribution of the transmission permission, priority handling, or band control among the multiple subscribers can be implemented by a simple configuration.

Further, with respect to a mechanism for specifying the subscriber resident apparatus of the destination, which is necessary in PDS for accomplishing security of the downward main signal, the subscriber resident apparatus of the destination is specified with a set of the apparatus ID assigned to the subscriber resident apparatus as a unique number and the subscriber ID embedded in the Ethernet frame. Therefore, it becomes possible to easily construct a network which is highly compatible with the Ethernet.

Having thus described several particular embodiments of the present invention, various alterations, modifications, and improvements will readily occur to those skilled in the art. Such alterations, modifications, and improvements are intended to be part of this disclosure, and are intended to be within the spirit and scope of the present invention. Accordingly, the foregoing description is by way of example only, and is not intended to be limiting. The present invention is limited only as defined in the following claims and the equivalents thereto.

What is claimed is:

1. An optical communication system having a station apparatus and multiple subscriber resident apparatuses connected to the station apparatus and sending/receiving data by optical communication between the station apparatus and the multiple subscriber resident apparatuses,
wherein the station apparatus selects a specific subscriber resident apparatus among the multiple subscriber resident apparatuses as a selected subscriber resident apparatus, generates transmission permission issuance information for issuing data transmission permission to the selected subscriber resident apparatus, and sends the transmission permission issuance information to the multiple subscriber resident apparatuses, and
wherein each of the multiple subscriber resident apparatuses receives the transmission permission issuance information sent from the station apparatus, checks if the transmission permission issuance information is destined to a subscriber resident apparatus itself, sends predetermined data to the station apparatus as upward main data when the transmission permission issuance information is destined to the subscriber resident apparatus itself, and does not send any data to the station apparatus when the transmission permission issuance information is not destined to the subscriber resident apparatus itself.

2. The optical communication system of claim 1, wherein each of the multiple subscriber resident apparatuses does not send any data to the station apparatus until the subscriber resident apparatus receives the transmission permission issuance information destined to the subscriber resident apparatus itself.

3. The optical communication system of claim 1, wherein each of the multiple subscriber resident apparatuses is provided with an apparatus ID as identification information,
wherein the station apparatus generates the transmission permission issuance information including an apparatus ID of the selected subscriber resident apparatus and sends the transmission permission issuance information generated to the multiple subscriber resident apparatuses, and
wherein each of the multiple subscriber resident apparatuses receives the transmission permission issuance information sent from the station apparatus and checks if the transmission permission issuance information received is destined to the subscriber resident apparatus itself based on the apparatus ID of the selected subscriber resident apparatus included in the transmission permission issuance information received.

4. The optical communication system of claim 1, wherein each of the multiple subscriber resident apparatuses is provided with an apparatus ID as identification information, sends the upward main data including the apparatus ID of the subscriber resident apparatus itself when receiving the transmission permission issuance information destined to the subscriber resident apparatus itself, and
wherein the station apparatus checks if the apparatus ID included in the upward main data received and the apparatus ID of the selected subscriber resident apparatus match when the upward main data is received from any of the multiple subscriber resident apparatuses, holds the upward main data received when the apparatus ID included in the upward main data received and the apparatus ID of the selected subscriber resident apparatus match, and discards the upward main data received when the apparatus ID included in the upward main data received and the apparatus ID of the selected subscriber resident apparatus do not match.

5. The optical communication system of claim 1, wherein each of the multiple subscriber resident apparatuses is connected to a subscriber network for sending the upward main data and receives the upward main data from the subscriber network to which the subscriber resident apparatus itself is connected,
wherein the subscriber network connected to each of the multiple subscriber resident apparatuses is provided a subscriber ID as identification information and sends the upward main data including the subscriber ID provided,
wherein the station apparatus inserts the subscriber ID of the subscriber network connected to the selected subscriber resident apparatus into the transmission permission issuance information and sends transmission permission issuance information including the subscriber ID to the multiple subscriber resident apparatuses,
wherein each of the multiple subscriber resident apparatuses extracts the subscriber ID included in the transmission permission issuance information when the transmission permission issuance information destined to the subscriber resident apparatus itself is received, checks if the subscriber ID which matches the subscriber ID extracted, is included in the upward main data received from the subscriber network connected to the subscriber resident apparatus itself and sends the upward main data received to the station apparatus when the subscriber ID which matches the subscriber ID extracted is included in the upward main data received, and
wherein the station apparatus, when the upward main data is received from any of the multiple subscriber resident apparatuses, checks if the subscriber ID included in the upward main data received matches the subscriber ID included in the transmission permission issuance information, holds the upward main data received when the subscriber ID included in the upward main data received matches the subscriber ID included in the transmission permission issuance information, and discards the upward main data received when the subscriber ID included in the upward main data received does not match the subscriber ID included in the transmission permission issuance information.

6. The optical communication system of claim 1,
wherein each of the multiple subscriber resident apparatuses, when the transmission permission issuance information destined to the subscriber resident apparatus itself is received, sends the upward main data to the station apparatus, and when transmission of the upward main data has been completed, sends transmission completion information notifying completion of the transmission of the upward main data to the station apparatus, and
wherein the station apparatus, when the transmission completion information is received from the selected subscriber resident apparatus, selects another subscriber resident apparatus other than the selected subscriber resident apparatus out of the multiple subscriber resident apparatuses as a next selected subscriber resident apparatus.

7. The optical communication system of claim 1, wherein the station apparatus comprises an observation timer, activates the observation timer when the transmission permission issuance information is sent, and when the upward main data is not received after the observation timer reaches a predetermined timer value, selects another subscriber resident apparatus other than the selected subscriber resident apparatus out of the multiple subscriber resident apparatuses as a next selected subscriber resident apparatus.

8. The optical communication system of claim 3, wherein the station apparatus destines a specific subscriber resident apparatus and sends downward main data including an apparatus ID of a destined subscriber resident apparatus to the multiple subscriber resident apparatuses, and
wherein each of the multiple subscriber resident apparatuses receives the downward main data sent from the station apparatus, checks if the downward main data received is destined to the subscriber resident apparatus itself based on the apparatus ID of the destined subscriber resident apparatus included in the downward main data received, holds the downward main data received when the downward main data received is destined to the subscriber resident apparatus itself, and discards the downward main data received when the downward main data received is not destined to the subscriber resident apparatus itself.

9. The optical communication system of claim 4, wherein the station apparatus destines a specific subscriber network and sends the downward main data including a subscriber ID of a destined subscriber network to the multiple subscriber resident apparatuses, and
wherein each of the multiple subscriber resident apparatuses receives the downward main data sent from the station apparatus, checks if the downward main data received is for the subscriber resident apparatus itself based on the subscriber ID included in the downward main data received, sends the downward main data received to the subscriber network connected to the subscriber resident apparatus itself when the downward main data received is for the subscriber resident apparatus itself, and discards the downward main data received when the downward main data received is not for the subscriber resident apparatus itself.

10. The optical communication system of claim 1, wherein each of the multiple subscriber resident apparatuses is provided with an apparatus ID as identification information, when the transmission permission issuance information destined to the subscriber resident apparatus itself, generates transmission start information notifying start of transmission of the upward main data before the transmission of the upward main data, appends the apparatus ID of the subscriber resident apparatus itself to the transmission start information generated, sends the transmission start information generated to which the apparatus ID of the subscriber resident apparatus itself is appended, sends the upward main data to the station apparatus after sending the transmission start information, generates transmission completion information notifying completion of transmission of the upward main data when the transmission of the upward main data is completed, appends the apparatus ID of the subscriber resident apparatus itself to the transmission completion information generated, and sends the transmission completion information to which the apparatus ID of the subscriber resident apparatus itself is appended to the station apparatus, and
wherein the station apparatus, when the transmission start information, the upward main data, and the transmission completion information sent from any of the multiple subscriber resident apparatuses are received, checks if the apparatus ID appended to the transmission start information and the apparatus ID appended to the transmission completion information match the apparatus ID of the selected subscriber resident apparatus, holds the upward main data received when the apparatus ID appended to the transmission start information and the apparatus ID appended to the transmission completion information match the apparatus ID of the selected subscriber resident apparatus, and discards the upward main data received when the apparatus ID appended to the transmission start information and the apparatus ID appended to the transmission completion information do not match the apparatus ID of the selected subscriber resident apparatus.

11. The optical communication system of claim 1, wherein each of the multiple subscriber resident apparatuses is connected to a subscriber network for sending the upward main data and receives the upward main data from the subscriber network to which the subscriber resident apparatus itself is connected,
wherein the subscriber network connected to the subscriber resident apparatus is provided with a subscriber ID as identification information,
wherein the station apparatus inserts the subscriber ID of the subscriber network connected to the selected subscriber resident apparatus into the transmission permission issuance information and sends the transmission permission issuance information including the subscriber ID to the multiple subscriber resident apparatuses,
wherein each of the multiple subscriber resident apparatuses, when the transmission permission issuance information to the subscriber resident apparatus itself is received, extracts the subscriber ID included in the transmission permission issuance information, generates transmission start information notifying start of transmission of the upward main data before the transmission of the upward main data, appends the subscriber ID extracted to the transmission start information generated, sends the transmission start information to which the subscriber ID extracted is appended to the station apparatus, sends the upward main data to the station apparatus after sending the transmission start information, generates transmission completion information notifying completion of the transmission of the upward main data when the transmission of the upward main data is completed, appends the subscriber ID extracted to the transmission completion information generated, and sends the transmission completion information to which the subscriber ID extracted is appended to the station apparatus, and
wherein the station apparatus, when the transmission start information, the upward main data, and the transmission completion information are received from any of the multiple subscriber resident apparatuses, checks if the subscriber ID appended to the transmission start information and the subscriber ID appended to the transmission completion information match the subscriber ID included in the transmission permission issuance information, holds the upward main data received when the subscriber ID appended to the transmission start information and the subscriber ID appended to the transmission completion information match the subscriber ID included in the transmission permission issuance information, and discards the upward main data received when the subscriber ID appended to the transmission start information and the subscriber ID appended to the transmission completion information do not match the subscriber ID included in the transmission permission issuance information.

12. The optical communication system of claim 1, wherein each of the multiple subscriber resident apparatuses is connected to a subscriber network for sending the upward main data and receives the upward main data including a sender's address from the subscriber network to which the subscriber resident apparatus itself is connected,
wherein the station apparatus is connected to a downward main data sending apparatus for sending downward main data to the station apparatus and receives the downward main data including a destination address from the downward main data sending unit,
wherein each of the subscriber resident apparatuses, when the transmission permission issuance information for the subscriber resident apparatus itself, sends the upward main data received from the subscriber network to which the subscriber resident apparatus itself is connected, to the station apparatus,
wherein the station apparatus, when the upward main data is received from any of the multiple subscriber resident apparatuses, stores the sender's address included in the upward main data received and an apparatus ID of the selected subscriber resident apparatus correspondingly, when the downward main data is received from the downward main data sending apparatus, compares the destination address included in the downward main data received with the sender's address stored, when the destination address and the sender's address match, scrambles the downward main data received using the apparatus ID of the selected subscriber resident apparatus stored correspondingly to the sender's address, and sends the downward main data scrambled to the multiple subscriber resident apparatuses,
wherein each of the multiple subscriber resident apparatuses receives the downward main data scrambled and sent from the station apparatus, descrambles the downward main data scrambled using the apparatus ID of the subscriber resident apparatus itself, sends the downward main data descrambled to the subscriber network to which the subscriber resident apparatus itself is connected when the downward main data scrambled is properly descrambled, and discards the downward main data scrambled and received when the downward main data scrambled is not properly descrambled.

13. The optical communication system of claim 1, wherein the station apparatus sends a apparatus status information request, which requests transmission of apparatus status information showing apparatus status of each of the multiple subscriber resident apparatuses, and which shows a predetermined delay time for each of the multiple subscriber apparatus, to the multiple subscriber resident apparatuses, and
wherein each of the multiple subscriber resident apparatuses, when the apparatus status information request is received, sends the apparatus status information showing the apparatus status of the subscriber resident apparatus itself to the station apparatus after the predetermined delay time for the subscriber resident apparatus itself shown in the apparatus status information request passes.

14. The optical communication system of claim 13, wherein the station apparatus generates transmission permission issuance information including the apparatus status information request as transmission permission issuance information with request and sends the transmission permission issuance information with request to the multiple subscriber resident apparatuses, and
wherein each of the multiple subscriber resident apparatuses receives the transmission permission issuance information with request sent from the station apparatus and checks if the transmission permission issuance information with request received is destined to the subscriber resident apparatus itself, when the transmission permission issuance information with request is not destined to the subscriber resident apparatus itself, sends the apparatus status information showing the apparatus status of the subscriber resident apparatus itself to the station apparatus after the delay time for the subscriber resident apparatus itself shown in the transmission permission issuance information with request passes, when the transmission permission issuance information with request is destined to the subscriber resident apparatus itself, sends the upward main data to the station apparatus after the delay time for the subscriber resident apparatus itself shown in the transmission permission issuance information with request passes, generates transmission completion information notifying completion of the transmission of the upward main data after the transmission of the upward main data is completed, appends the apparatus status information showing the apparatus status of the subscriber resident apparatus itself to the transmission completion information generated, and sends the transmission completion information to which the apparatus status information is appended to the station apparatus.

15. The optical communication system of claim 1, wherein the station apparatus sends the transmission permission issuance information specifying transmission permitted data amount of the upward main data to the multiple subscriber resident apparatuses, and
wherein each of the multiple subscriber resident apparatuses, when the transmission permission issuance information for the subscriber resident apparatus itself is received, sends the upward main data to the station apparatus within the transmission permitted data amount specified in the transmission permission issuance information.

16. The optical communication system of claim 15, wherein each of the multiple subscriber resident apparatuses is connected to a subscriber network for sending upward main data and receives upward main data, which is divided by a predetermined unit data, by the unit data with a predetermined gapping time from the subscriber network to which the subscriber resident apparatus itself is connected, and
wherein each of the multiple subscriber resident apparatuses, when the transmission permission issuance information for the subscriber resident apparatus itself is received, measures a gapping time for each of the unit data of the upward main data received from the subscriber network to which the subscriber resident apparatus itself is connected, and sends the upward main data received to the station apparatus until the gapping time which exceeds a predetermined time is detected.

17. The optical communication system of claim 1, wherein the station apparatus is connected to a downward main data sending apparatus for sending downward main data to the station apparatus, and
wherein the station apparatus sends a suspension instructing signal instructing suspension of transmission of the downward main data to the downward main data sending apparatus in a predetermined case.

18. The optical communication system of claim 1, wherein each of the multiple subscriber resident apparatuses is connected to a subscriber network for sending upward main data, receives the upward main data sent from the subscriber network to which the subscriber resident apparatus itself is connected, and sends a suspension instructing signal instructing suspension of the transmission of the upward main data to the subscriber network to which the subscriber resident apparatus itself is connected in a predetermined case.

19. An optical communication method for sending/receiving data by optical communication between a station apparatus and multiple subscriber resident apparatuses,
wherein the station apparatus selects a specific subscriber resident apparatus among the multiple subscriber resident apparatuses as a selected subscriber resident apparatus, generates transmission permission issuance information for issuing data transmission permission to the selected subscriber resident apparatus, and sends the transmission permission issuance information to the multiple subscriber resident apparatuses, and
wherein each of the multiple subscriber resident apparatuses receives the transmission permission issuance information sent from the station apparatus, checks if the transmission permission issuance information is destined to a subscriber resident apparatus itself, sends predetermined data to the station apparatus as upward main data when the transmission permission issuance information is destined to the subscriber resident apparatus itself, and does not send any data to the station apparatus when the transmission permission issuance information is not destined to the subscriber resident apparatus itself.
